(19) United States
(12) Patent Application Publication
(10) Pub. No.: US 2026/0254098 A1
(43) Pub. Date: Aug. 27, 2026

(54) Mobile Terminal

(71) Applicant: HUAWEI TECHNOLOGIES CO., LTD., Shenzhen (CN)

(72) Inventors: Jikang Wang, Shanghai (CN); Dong Yu, Shanghai (CN); Zhixin Zhan, Shanghai (CN); Yiwen Gong, Shanghai (CN); Libin Lei, Dongguan (CN); Xiaohong Shi, Shanghai (CN); Linghua Yuan, Shanghai (CN)

(73) Assignee: HUAWEI TECHNOLOGIES CO., LTD., Shenzhen (CN)

(21) Appl. No.: 19/649,677

(22) Filed: Apr. 16, 2026

Related U.S. Application Data
(63) Continuation of application No. PCT/CN2024/115274, filed on Aug. 28, 2024.

(30) Foreign Application Priority Data
Jan. 15, 2024 (CN) 202410060075.2

(51) Int. Cl. H01Q 1/24; H01Q 21/30; H01Q 23/00

(52) U.S. Cl. CPC H01Q 1/243; H01Q 21/30; H01Q 23/00

(57) ABSTRACT

A mobile terminal includes a satellite antenna system that includes a satellite communication chip and at least two antennas. The at least two antennas include a first antenna and a second antenna configured to receive a radio frequency signal of a communication satellite. The first antenna and the second antenna are separately connected to the satellite communication chip, and at least a part of a first radiator of the first antenna and at least a part of a second radiator of the second antenna are located on different sides of the mobile terminal. An area of weak angle-dependent receiving sensitivity of the first antenna at least partially overlaps an area of strong angle-dependent receiving sensitivity of the second antenna.

### CROSS-REFERENCE TO RELATED APPLICATIONS

This is a continuation of International Patent Application No. PCT/CN2024/115274, filed on August 28, 2024, which claims priority to Chinese Patent Application No. 202410060075.2, filed on January 15, 2024, which are both incorporated by reference.

### TECHNICAL FIELD

This disclosure relates to the field of electronic device technologies, and in particular, to a mobile terminal.

### BACKGROUND

With development of human society, mobile terminals such as mobile phones have become indispensable tools in people's life. People's dependence on the mobile terminals has affected every aspect of life. With emergence of mobile terminals using communication satellites for communication, people have increasingly high requirements for actual use of communication satellite-based communication on the mobile terminals.

Due to a small quantity and great distances of communication satellites compared to base stations in use, powers of radio frequency signals from the communication satellites are relatively low when the radio frequency signals reach the ground. Therefore, to enhance communication satellite-based communication performance of a mobile terminal, a satellite antenna carried on the mobile terminal needs to have a relatively strong capability.

A signal beam of the satellite antenna has a directivity, and sufficient signal strength for communication satellite-based communication is available only within a specific beam angle. A mobile terminal may include one satellite antenna. To perform communication satellite-based communication, a use switch needs to be turned on to use the satellite antenna for a satellite call. In addition, during use, there is a need to pay attention to satellite alignment, that is, adjusting a pose of the mobile terminal. Relatively good call quality can be achieved only when the mobile terminal remains in a specific pose. Communication satellite-based communication on the existing mobile terminal is mainly used for initiating an active call. It is difficult for the mobile terminal in a standby state to remain aligned with a satellite, resulting in difficulty in implementing a function of receiving a call through communication satellite-based communication.

A mobile terminal provided in this disclosure includes a satellite antenna system. A strong area in which the satellite antenna system receives a radio frequency signal of a communication satellite has relatively wide coverage, so that a function of receiving a call through communication satellite-based communication can be implemented.

According to a first aspect, this disclosure provides a mobile terminal. The mobile terminal includes a satellite antenna system configured to implement a satellite communication function of the mobile terminal. The satellite antenna system includes a satellite communication chip and at least two antennas. For ease of description, it is considered that the at least two antennas include a first antenna and a second antenna. The first antenna includes a first radiator and a first radio frequency module that are connected to each other. Similarly, the second antenna includes a second radiator and a second radio frequency module that are connected to each other. The first antenna and the second antenna are configured to receive a radio frequency signal of a communication satellite, to implement downlink communication of the mobile terminal, so that a function of receiving a call by the mobile terminal is implemented. The first radio frequency module and the second radio frequency module are separately connected to the satellite communication chip, so that the radio frequency signal received by the first radiator is transmitted to the satellite communication chip after being converted by the first radio frequency module, and the radio frequency signal received by the second radiator is also transmitted to the satellite communication chip after being converted by the second radio frequency module. At least a part of the first radiator and at least a part of the second radiator are located on different sides of the mobile terminal, so that a beam direction of the first radiator can be different from a beam direction of the second radiator, thereby helping expand coverage of an area of strong angle-dependent receiving sensitivity of the satellite antenna system. An area of weak angle-dependent receiving sensitivity of the first antenna at least partially overlaps an area of strong angle-dependent receiving sensitivity of the second antenna. Therefore, a total area covered by an area of strong angle-dependent receiving sensitivity of the first antenna and the area of strong angle-dependent receiving sensitivity of the second antenna is relatively large, so that the satellite antenna system of the mobile terminal covers a relatively wide area. In this way, difficulty in satellite alignment during use is reduced, and the mobile terminal can receive the radio frequency signal of the communication satellite in a relatively large quantity of poses. This helps improve a downlink communication effect of communication satellite-based communication on the mobile terminal, so that the mobile terminal can have a function of receiving a call through communication satellite-based communication. In a technical solution, the mobile terminal is configured to implement at least one of satellite messaging, satellite calling, or satellite internet access via the satellite communication chip.

In a technical solution, each of the at least two antennas in a satellite communication system includes a corresponding radiator and a corresponding radio frequency module, the radiator of each antenna is connected to the corresponding radio frequency module, and the corresponding radio frequency module is connected to the satellite communication chip. Each antenna is configured to receive a radio frequency signal of the communication satellite, so that the area of strong angle-dependent receiving sensitivity of the satellite antenna system has relatively wide coverage. If the area of strong angle-dependent receiving sensitivity of the satellite antenna system covers at least 80% of a full sphere, the satellite antenna system may be considered as an omnidirectional antenna system. The satellite antenna system has a strength within an omnidirectional range of spherical coordinates. In this case, the mobile terminal can communicate with the communication satellite without remaining in a specific pose. The mobile terminal can receive the radio frequency signal of the communication satellite in a normal state, so that the mobile terminal remains in a called state. The normal state means that the mobile terminal does not perform an additional satellite alignment operation, and may be located at any position in free space, or may be located at any position such as a bag or a pocket. This solution can enrich satellite communication scenarios of the mobile terminal.

In a technical solution, an area of weak angle-dependent receiving sensitivity of an antenna in the satellite antenna system at least partially overlaps an area of strong angle-dependent receiving sensitivity of another antenna in the satellite antenna system. In this way, different areas are basically covered by the area of strong angle-dependent receiving sensitivity, so that the satellite antenna system becomes the omnidirectional antenna system, or in other words, the satellite antenna system of the mobile terminal can omnidirectionally receive the radio frequency signal of the communication satellite.

The area of strong angle-dependent receiving sensitivity is an area in which an angle-dependent receiving sensitivity is less than or equal to a first threshold, and the area of weak angle-dependent receiving sensitivity is an area in which an angle-dependent receiving sensitivity is greater than the first threshold. During detection of the area of strong angle-dependent receiving sensitivity of the antenna, a negative value is detected, that is, the first threshold is a negative value. Therefore, a smaller value of the angle-dependent receiving sensitivity indicates a higher strength. From a perspective of an absolute value, a larger absolute value of the detected angle-dependent receiving sensitivity indicates a higher strength.

The first threshold may be –121 decibel-milliwatts (dBm). In this case, the area of strong angle-dependent receiving sensitivity is an area in which an angle-dependent receiving sensitivity is less than or equal to –121 dBm, and the area of weak angle-dependent receiving sensitivity is an area in which an angle-dependent receiving sensitivity is greater than –121 dBm. Settings that meet the foregoing requirements can meet most communication requirements of the communication satellite.

In a further technical solution, at least one antenna in the satellite antenna system is further configured to transmit a signal to the communication satellite, to implement uplink communication, so that a call function of the satellite antenna system can be implemented. An area of strong angle-dependent transmitting sensitivity of the satellite antenna system covers at least 80% of an upper hemisphere of the mobile terminal in use, so that an uplink communication effect of the mobile terminal can be improved.

In the at least two antennas in the satellite antenna system, a quantity of antennas configured to transmit a signal to the communication satellite is not limited. In an embodiment, the at least two antennas in the satellite antenna system are further configured to transmit a signal to the communication satellite. In the antennas configured to transmit a signal to the communication satellite, an area of weak angle-dependent transmitting sensitivity of an antenna at least partially overlaps an area of strong angle-dependent transmitting sensitivity of another antenna. In this way, coverage of the area of strong angle-dependent transmitting sensitivity of the satellite antenna system of the mobile terminal is improved, and call quality of the mobile terminal is improved.

In a technical solution, the area of strong angle-dependent transmitting sensitivity is an area in which an angle-dependent transmitting sensitivity is greater than or equal to a second threshold, and the area of weak angle-dependent transmitting sensitivity is an area in which an angle-dependent transmitting sensitivity is less than the second threshold. When an angle-dependent transmitting sensitivity of the satellite antenna system of the mobile terminal is greater than or equal to the second threshold, a signal can be efficiently transmitted to the communication satellite, to implement communication of the mobile terminal. On the contrary, when the angle-dependent transmitting sensitivity of the satellite antenna system of the mobile terminal is less than the second threshold, it is difficult to transmit a signal to the communication satellite, resulting in difficulty in implementing communication of the mobile terminal.

The second threshold may be 25.5 dBm. The area of strong angle-dependent transmitting sensitivity is an area in which an angle-dependent transmitting sensitivity is greater than or equal to 25.5 dBm, and the area of weak angle-dependent transmitting sensitivity is an area in which an angle-dependent transmitting sensitivity is less than 25.5 dBm. Settings that meet the foregoing requirements can meet most communication requirements of the communication satellite.

In a technical solution, each antenna in the satellite antenna system may be configured to transmit a signal to the communication satellite, so that a satellite communication effect of the mobile terminal in different poses is improved, and communication quality is improved.

To improve quality of the signal transmitted by the antenna to the communication satellite, the radio frequency module of the antenna that transmits the signal to the communication satellite includes a power amplifier, and the power amplifier is connected to the satellite communication chip to process the communication signal. In a technical solution, the radio frequency module of each antenna in the satellite antenna system includes a power amplifier.

To reduce a loss on a signal transmission path, a distance between the power amplifier and the connected radiator is relatively short, so that a length of a line between the power amplifier and the radiator is shortened, to reduce a link loss and improve signal transmission efficiency.

In a technical solution, the first radio frequency module includes a first power amplifier, and the first power amplifier is connected to the first radiator; and the second radio frequency module includes a second power amplifier, and the second power amplifier is connected to the second radiator. A distance between the first radiator and the first power amplifier is less than a distance between the second radiator and the first power amplifier, to reduce the link loss and improve the signal transmission efficiency.

In a technical solution, the power amplifier is a distributed radio frequency terminal. The distance between the power amplifier of the mobile terminal and the connected radiator is less than a distance between the power amplifier and the satellite communication chip. A power amplifier of an antenna is disposed closer to a connected radiator, thereby helping reduce the link loss.

The satellite communication system further includes a control switch. The control switch is connected to the satellite communication chip, and the control switch is connected to the radio frequency modules of all the antennas. The control switch is configured to connect one or more antennas to the satellite communication chip based on a pose of the mobile terminal, a transmit signal strength of the antenna, and/or a position of an area of strong angle-dependent transmitting sensitivity of the antenna. In conclusion, a working antenna may be selected based on a requirement, so that the one or more antennas that are connected to the satellite communication chip and that are in the satellite communication system of the mobile terminal are in a working state for signal transmission.

In a technical solution, the mobile terminal includes a metal side frame, and a partial structure of the metal side frame forms the radiator of the antenna. The metal side frame may be a middle frame of the mobile terminal. In this embodiment, the radiator of the antenna may be reused with the middle frame of the mobile terminal, to reduce space occupied by the radiator of the antenna and improve integration of the mobile terminal. In addition, the radiator of the antenna is less blocked, which helps improve a communication effect of the antenna.

In a technical solution, when the satellite antenna system includes two antennas, the first radiator and the second radiator of the satellite antenna system are respectively disposed on two sides of the mobile terminal that are away from each other. In this way, the first antenna and the second antenna can be complementary to each other, so that the satellite antenna system of the mobile terminal covers a relatively wide area. This helps improve the downlink communication effect of communication satellite-based communication on the mobile terminal, so that the mobile terminal can have the function of receiving a call through communication satellite-based communication.

In a technical solution, the satellite antenna system includes three antennas: the first antenna, the second antenna, and a third antenna. The third antenna includes a third radiator and a third radio frequency module that are connected to each other, the third radio frequency module is also connected to the satellite communication chip, and the first radiator, the second radiator, and the third radiator are respectively disposed on three different sides of the mobile terminal. In this way, downlink directivity patterns of the three antennas are complementary to each other, so that the satellite antenna system of the mobile terminal covers a relatively wide area. Therefore, the mobile terminal can have the function of receiving a call through communication satellite-based communication.

In a technical solution, the satellite antenna system includes four antennas: the first antenna, the second antenna, a third antenna, and a fourth antenna. The third antenna includes a third radiator and a third radio frequency module that are connected to each other, the fourth antenna includes a fourth radiator and a fourth radio frequency module that are connected to each other, and the third radio frequency module and the fourth radio frequency module are also separately connected to the satellite communication chip. The first radiator, the second radiator, the third radiator, and the fourth radiator are respectively disposed on four different sides of the mobile terminal. Downlink directivity patterns of the four antennas are complementary to each other, so that the satellite antenna system of the mobile terminal covers a relatively wide area. In this way, difficulty in satellite alignment during use is reduced, and the mobile terminal can receive the radio frequency signal of the communication satellite in a relatively large quantity of poses. This helps improve the downlink communication effect of communication satellite-based communication on the mobile terminal, so that the mobile terminal can have the function of receiving a call through communication satellite-based communication.

According to a second aspect, this disclosure further provides a mobile terminal. The mobile terminal includes a satellite antenna system configured to implement a satellite communication function of the mobile terminal. The satellite antenna system includes a satellite communication chip and at least two antennas. At least one antenna in the satellite antenna system is configured to transmit a signal to a communication satellite, to implement a call function of the mobile terminal. An area of strong angle-dependent transmitting sensitivity of the satellite antenna system covers at least 80% of an upper hemisphere of the mobile terminal in use. Therefore, the satellite antenna system of the mobile terminal covers a relatively wide area. In this way, difficulty in satellite alignment during use is reduced, and the mobile terminal can transmit a radio frequency signal to the communication satellite in a relatively large quantity of poses. This helps improve an uplink communication effect of communication satellite-based communication on the mobile terminal, so that the mobile terminal can have a function of receiving a call through communication satellite-based communication. In a technical solution, the mobile terminal is configured to implement at least one of satellite messaging, satellite calling, or satellite internet access via the satellite communication chip.

In the at least two antennas in the satellite antenna system, a quantity of antennas configured to transmit a signal to the communication satellite is not limited. In an embodiment, the at least two antennas in the satellite antenna system are further configured to transmit a signal to the communication satellite. In the antennas configured to transmit a signal to the communication satellite, an area of weak angle-dependent transmitting sensitivity of an antenna at least partially overlaps an area of strong angle-dependent transmitting sensitivity of another antenna. In this way, coverage of the area of strong angle-dependent transmitting sensitivity of the satellite antenna system of the mobile terminal is improved, and call quality of the mobile terminal is improved.

In a technical solution, the area of strong angle-dependent transmitting sensitivity is an area in which an angle-dependent transmitting sensitivity is greater than or equal to a second threshold, and the area of weak angle-dependent transmitting sensitivity is an area in which an angle-dependent transmitting sensitivity is less than the second threshold. When an angle-dependent transmitting sensitivity of the satellite antenna system of the mobile terminal is greater than or equal to the second threshold, a signal can be efficiently transmitted to the communication satellite, to implement communication of the mobile terminal. On the contrary, when the angle-dependent transmitting sensitivity of the satellite antenna system of the mobile terminal is less than the second threshold, it is difficult to transmit a signal to the communication satellite, resulting in difficulty in implementing communication of the mobile terminal.

The second threshold may be 25.5 dBm. The area of strong angle-dependent transmitting sensitivity is an area in which an angle-dependent transmitting sensitivity is greater than or equal to 25.5 dBm, and the area of weak angle-dependent transmitting sensitivity is an area in which an angle-dependent transmitting sensitivity is less than 25.5 dBm. Settings that meet the foregoing requirements can meet most communication requirements of the communication satellite.

In a technical solution, each antenna in the satellite antenna system may be configured to transmit a signal to the communication satellite, so that a satellite communication effect of the mobile terminal in different poses is improved, and communication quality is improved.

To improve quality of the signal transmitted by the antenna to the communication satellite, a radio frequency module of the antenna that transmits the signal to the communication satellite includes a power amplifier, and the power amplifier is connected to the satellite communication chip to process the communication signal. In a technical solution, a radio frequency module of each antenna in the satellite antenna system includes a power amplifier.

To reduce a loss on a signal transmission path, a distance between the power amplifier and a connected radiator is relatively short, so that a length of a line between the power amplifier and the radiator is shortened, to reduce a link loss and improve signal transmission efficiency.

In a technical solution, a first radio frequency module includes a first power amplifier, and the first power amplifier is connected to a first radiator; and a second radio frequency module includes a second power amplifier, and the second power amplifier is connected to a second radiator. A distance between the first radiator and the first power amplifier is less than a distance between the second radiator and the first power amplifier, to reduce the link loss and improve the signal transmission efficiency.

In a technical solution, the power amplifier is a distributed radio frequency terminal. The distance between the power amplifier of the mobile terminal and the connected radiator is less than a distance between the power amplifier and the satellite communication chip. A power amplifier of an antenna is disposed closer to a connected radiator, thereby helping reduce the link loss.

The satellite communication system further includes a control switch. The control switch is connected to the satellite communication chip, and the control switch is connected to the radio frequency modules of all the antennas. The control switch is configured to connect one or more antennas to the satellite communication chip based on a pose of the mobile terminal, a transmit signal strength of the antenna, and/or a position of an area of strong angle-dependent transmitting sensitivity of the antenna. In conclusion, a working antenna may be selected based on a requirement, so that the one or more antennas that are connected to the satellite communication chip and that are in the satellite communication system of the mobile terminal are in a working state for signal transmission.

In a technical solution, the mobile terminal includes a metal side frame, and a partial structure of the metal side frame forms the radiator of the antenna. The metal side frame may be a middle frame of the mobile terminal. In this embodiment, the radiator of the antenna may be reused with the middle frame of the mobile terminal, to reduce space occupied by the radiator of the antenna and improve integration of the mobile terminal. In addition, the radiator of the antenna is less blocked, which helps improve a communication effect of the antenna.

### BRIEF DESCRIPTION OF DRAWINGS

FIG. 1 is a diagram of satellite communication performed by a mobile terminal according to an embodiment of this disclosure.

FIG. 2 is a diagram of a structure of an electronic device according to an embodiment of this disclosure.

FIG. 3 is a diagram of a structure of a mobile terminal according to an embodiment of this disclosure.

FIG. 4 shows a downlink directivity pattern of a satellite antenna system of the mobile terminal in the embodiment shown in FIG. 3.

FIG. 5 shows an uplink directivity pattern of a satellite antenna system of the mobile terminal in the embodiment shown in FIG. 3.

FIG. 6 is a diagram of a structure of a mobile terminal according to an embodiment of this disclosure.

FIG. 7 is a diagram of a structure of a mobile terminal according to an embodiment of this disclosure.

FIG. 8 shows a downlink directivity pattern of a satellite antenna system of the mobile terminal in the embodiment shown in FIG. 7.

FIG. 9 is a diagram of another structure of a mobile terminal according to an embodiment of this disclosure.

FIG. 10 shows a downlink directivity pattern of a satellite antenna system of the mobile terminal in the embodiment shown in FIG. 9.

### DETAILED DESCRIPTION

To make objectives, technical solutions, and advantages of this disclosure clearer, the following further describes this disclosure in detail with reference to the accompanying drawings.

Terms used in the following embodiments are merely intended to describe specific embodiments, but are not intended to limit this disclosure. The terms "one", "a", "the", "the foregoing", and "this" of singular forms used in this specification and the appended claims of this disclosure are also intended to include expressions such as "one or more", unless otherwise specified in the context clearly.

Reference to "an embodiment", "a specific embodiment", or the like described in this specification means that one or more embodiments of this disclosure include a specific feature, structure, or characteristic described with reference to this embodiment. The terms "include", "have", and their variants all mean "include but are not limited to", unless otherwise specifically emphasized in another manner.

For ease of understanding a mobile terminal provided in embodiments of this disclosure, the following first describes application scenarios of the mobile terminal.

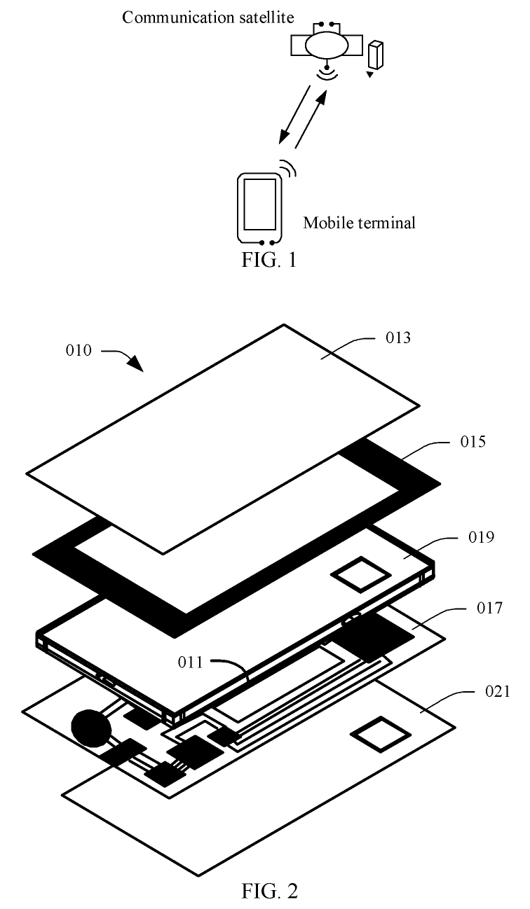

FIG. 1 is a diagram of satellite communication performed by a mobile terminal according to an embodiment of this disclosure. As shown in FIG. 1, communication satellite-based communication belongs to non-terrestrial network (NTN) communication, and can be used for communication with the mobile terminal. Compared with terrestrial communication, communication satellite-based communication can provide wider coverage. Especially for an area with sparse or insufficient cellular communication base station deployment, a communication satellite may be used for communication. According to an orbit height of a satellite, a satellite communication system can be classified into three types: a geostationary earth orbit (GEO) satellite communication system (also referred to as a geosynchronous communication satellite), a medium earth orbit (MEO) satellite communication system, and a low earth orbit (LEO) satellite communication system. A GEO satellite has an orbit height of 35786 kilometers (km). A main advantage is that the GEO satellite can remain stationary relative to the ground and provide a large coverage area. An MEO satellite has an orbit height of 2000 km to 35786 km. An advantage is that global coverage can be achieved through a relatively small quantity of satellites. Based on advantages and disadvantages of MEO satellite communication, the MEO satellite may be used for positioning and navigation. An LEO satellite has an orbit height of 300 km to 2000 km. The LEO satellite has a lower orbit height than the MEO and the GEO, and has advantages of a short data transmission delay, a small transmission loss, and low transmission costs.

To use the communication satellite for communication, the mobile terminal is provided with a satellite antenna. However, a signal beam of the satellite antenna has a directivity. A mobile terminal in various technologies includes one satellite antenna. To perform communication satellite-based communication, a use switch needs to be turned on to use the satellite antenna for a satellite call. In addition, during use, there is a need to pay attention to alignment of the satellite antenna with the satellite, that is, adjusting a pose of the mobile terminal. Relatively good call quality can be achieved only when the mobile terminal remains in a specific pose. In addition, communication satellite-based communication on the existing mobile terminal is mainly used for initiating an active call. It is difficult for the mobile terminal in a standby state to remain aligned with a satellite, resulting in difficulty in implementing a function of receiving a call through communication satellite-based communication.

Therefore, this disclosure provides a mobile terminal. The mobile terminal includes at least two satellite antennas, to implement a function of receiving a call by the mobile terminal through a communication satellite.

FIG. 2 is a diagram of a structure of an electronic device according to an embodiment of this disclosure. As shown in FIG. 2, an example in which the electronic device is a mobile phone is used. An electronic device 010 may include a cover 013, a display/module 015, a printed circuit board (PCB) 017, a middle frame 019, and a rear cover 021. It should be understood that, in some embodiments, the cover 013 may be a cover glass, or may be replaced with a cover made of another material, for example, an ultra-thin glass cover or a cover made of a polyethylene terephthalate (PET) material.

The cover 013 may be tightly attached to the display 015, and mainly provides protection and dust prevention for the display 015.

In an embodiment, the display 015 may include a liquid-crystal display (LCD) panel, a light-emitting diode (LED) display panel, an organic LED (OLED) display panel, or the like. This is not limited in this disclosure.

The middle frame 019 mainly supports the entire device. FIG. 2 shows that the PCB 017 is disposed between the middle frame 019 and the rear cover 021. It should be understood that, in an embodiment, the PCB 017 may alternatively be disposed between the middle frame 019 and the display 015. This is not limited in this disclosure. The printed circuit board PCB 017 may be a flame-retardant material (e.g., FR-4) dielectric board, a Rogers dielectric board, a hybrid dielectric board of Rogers and FR-4, or the like. Herein, FR-4 is a grade designation of a flame-retardant material, and the Rogers dielectric board is a high-frequency board. An electronic element, for example, a radio frequency chip, is carried on the PCB 017.

The electronic device 010 may further include a battery (not shown in the figure). The battery may be disposed between the middle frame 019 and the rear cover 021, or may be disposed between the middle frame 019 and the display 015. This is not limited in this disclosure. In some embodiments, the PCB 017 is divided into a main board and a sub-board. The battery may be disposed between the main board and the sub-board. The main board may be disposed between the middle frame 019 and an upper edge of the battery, and the sub-board may be disposed between the middle frame 019 and a lower edge of the battery.

The electronic device 010 may further include a side frame 011. The side frame 011 may be made of a conductive material, for example, a metal. The side frame 011 may be disposed between the display 015 and the rear cover 021 and extend around a periphery of the electronic device 010. The side frame 011 may have four sides surrounding the display 015, to help fasten the display 015. In an implementation, the side frame 011 made of a metal material may be directly used as a metal side frame of the electronic device 010 to form an appearance of the metal side frame, and is applicable to a metal industrial design (ID). In another implementation, an outer surface of the side frame 011 may alternatively be made of a non-metal material, for example, a plastic side frame, to form an appearance of a non-metal side frame, and is applicable to a non-metal ID.

The middle frame 019 may include the side frame 011, and the middle frame 019 including the side frame 011 is used as an integrated part, and may support an electronic component in the entire device. The cover 013 and the rear cover 021 are respectively closed along an upper edge and a lower edge of the side frame, to form a casing or a housing of the electronic device. Alternatively, the side frame 011 may not be considered as a part of the middle frame 019. In an embodiment, the side frame 011 and the middle frame 019 may be connected and integrally formed. In another embodiment, the side frame 011 may include a protrusion member extending inward, to be connected to the middle frame 019, for example, connected through a spring or a screw, or connected through welding. In an embodiment, the cover 013, the rear cover 021, the side frame 011, and the middle frame 019 may be collectively referred to as the casing or the housing of the electronic device 010. It should be understood that the "casing or housing" may mean a part or all of any one of the cover 013, the rear cover 021, the side frame 011, and the middle frame 019, or mean a part or all of any combination of the cover 013, the rear cover 021, the side frame 011, and the middle frame 019.

The rear cover 021 may be a rear cover made of a metal material; or may be a rear cover made of a non-conductive material, for example, a glass rear cover, a plastic rear cover, or another non-metal rear cover; or may be a rear cover made of both a conductive material and a non-conductive material.

In an embodiment, the rear cover 021 including the conductive material may replace the middle frame 019, and is used as an integrated part with the side frame 011, to support an electronic component in the entire device.

In an embodiment, the middle frame 019 and/or the conductive part in the rear cover 021 may be used as reference ground of the electronic device 010. The side frame 011, the PCB 017, and the like of the electronic device may be electrically connected to the middle frame 019 for grounding.

In an embodiment, at least a part of the side frame 011 may be used as an antenna radiator to receive/transmit a radio frequency signal. There may be a gap between the part of the side frame used as the radiator and another part of the middle frame 019 or between the part of the side frame and the middle frame 019, to ensure that the antenna radiator has a good radiation environment. In an embodiment, an aperture may be provided near the part of the side frame used as the antenna radiator. In an embodiment, the aperture may include an aperture provided inside the electronic device 010, for example, an aperture that is invisible from an appearance surface of the electronic device 010. In an embodiment, the internal aperture may be formed by any one of or jointly formed by a plurality of the middle frame, the battery, the circuit board, the rear cover, the display, and another internal conductive part. For example, the internal aperture may be formed by a mechanical part of the middle frame. In an embodiment, the aperture may further include a slot/slit/hole disposed on the side frame 011. In an embodiment, the slot/slit/hole on the side frame 011 may be a gap formed on the side frame, and the side frame 011 is divided, at the gap, into two parts that have no direct connection relationship. In an embodiment, the aperture may further include a slot/slit/hole provided on the rear cover 021 or the display 015. In an embodiment, the rear cover 021 includes a conductive material, and an aperture provided on the conductive material may be connected to the slit or the gap of the side frame, to form a coherent aperture on the appearance surface of the electronic device 010.

In an embodiment, the side frame 011 includes a protrusion member extending inward, and is configured to connect to another part of the middle frame 019, or is configured to connect to the middle frame 019 (or may be integrally formed in an embodiment). In an embodiment, the protrusion member includes a conductive material, and may be further configured to receive a feed signal or connect to the ground plane, so that a corresponding side frame part receives/transmits a radio frequency signal.

In an embodiment, the antenna of the electronic device 010 may alternatively be disposed in the side frame 011. The side frame 011 includes a non-conductive material. The antenna radiator may be located in the electronic device 010 and disposed along the side frame 011, or at least a part of the antenna radiator may be embedded in the non-conductive material of the side frame. In an embodiment, the antenna radiator is disposed adjacent to the non-conductive material of the side frame 011, to minimize a volume occupied by the antenna radiator, and enable the antenna radiator to be closer to the outside of the electronic device 010, so as to achieve a better signal transmission effect. It should be noted that, that the antenna radiator is disposed adjacent to the side frame 011 means that the antenna radiator may be tightly attached to the side frame 011, or may be disposed close to the side frame 011. For example, there may be a small slot between the antenna radiator and the side frame 011.

In an embodiment, the antenna of the electronic device 010, for example, a bracketed antenna (not shown in FIG. 2), may alternatively be disposed in the casing. There may be a gap between the antenna disposed in the casing and another conductive part in the casing, to ensure that the antenna radiator has a good radiation environment. In an embodiment, an aperture may be provided near the antenna radiator. In an embodiment, the aperture may include an aperture provided inside the electronic device 010, for example, an aperture that is invisible from an appearance surface of the electronic device 010. In an embodiment, the internal aperture may be formed by any one of or jointly formed by a plurality of the side frame, the middle frame, the battery, the circuit board, the rear cover, the display, and another internal conductive part. For example, the internal aperture may be formed by a mechanical part of the middle frame. In an embodiment, the aperture may further include a slot/slit/hole disposed on the side frame 011. In an embodiment, the slot/slit/hole on the side frame 011 may be a gap formed on the side frame, and the side frame 011 is divided, at the gap, into two parts that have no direct connection relationship. In an embodiment, the aperture may further include a slot/slit/hole provided on the rear cover 021 or the display 015. In an embodiment, the rear cover 021 includes a conductive material, and an aperture provided on the conductive material may be connected to the slit or the gap of the side frame, to form a coherent aperture on the appearance surface of the electronic device 010. In an embodiment, the aperture on the rear cover 021 or the display may further be used to place another component, for example, a camera, and/or a sensor, and/or a microphone, and/or a speaker.

FIG. 2 shows only an example of some components included in the electronic device 010. Shapes, sizes, and structures of these components are not limited to those in FIG. 2.

It should be understood that, in embodiments of this disclosure, it may be considered that a surface on which the display of the electronic device is located is a front surface, a surface on which the rear cover is located is a rear surface, and a surface on which the side frame is located is a side surface.

It should be understood that, in embodiments of this disclosure, it is considered that when a user holds the electronic device (the user may hold the electronic device vertically and faces the screen), an orientation in which the electronic device is located has a top part, a bottom part, and a side part.

The mobile terminal in embodiments of this disclosure may have a plurality of choices, for example, may include any mobile terminal such as a bar phone, a foldable phone, a multi-fold mobile phone form, a tablet computer, or a smart display.

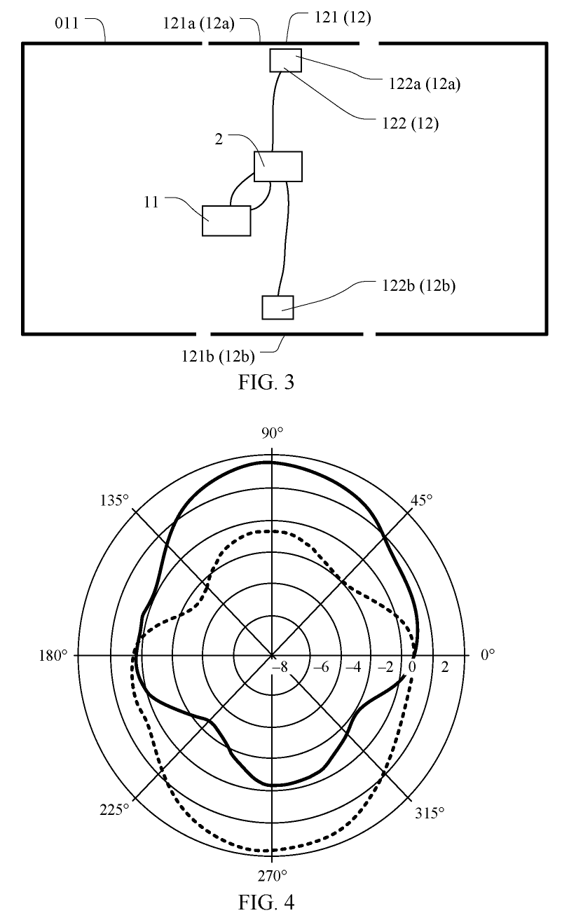

FIG. 3 is a diagram of a structure of a mobile terminal according to an embodiment of this disclosure. As shown in FIG. 3, the mobile terminal in this embodiment of this disclosure includes a satellite antenna system. The satellite antenna system is configured to receive/send an electromagnetic wave. The satellite antenna system is configured to: receive an electromagnetic wave of a communication satellite, or send an electromagnetic wave to a communication satellite. The satellite antenna system is configured to transmit the electromagnetic wave between the satellite antenna system and the communication satellite, so that a satellite communication function of the mobile terminal can be implemented.

As shown in FIG. 3, in an embodiment, the satellite antenna system includes a satellite communication chip 11 and at least two antennas 12. The antenna 12 includes a radiator 121 and a radio frequency module 122. The radiator 121 is connected to the radio frequency module 122, and the radio frequency module 122 is connected to the satellite communication chip 11. In this way, communication satellite-based communication is implemented through the satellite antenna system. In an embodiment, the mobile terminal is configured to implement at least one of satellite messaging, satellite calling, or satellite internet access via the satellite communication chip 11.

In an embodiment, the at least two antennas 12 include a first antenna 12a and a second antenna 12b, the first antenna 12a includes a first radiator 121a and a first radio frequency module 122a that are connected to each other, the second antenna 12b includes a second radiator 121b and a second radio frequency module 122b that are connected to each other, and the first antenna 12a and the second antenna 12b are configured to receive a radio frequency signal of the communication satellite. The first radio frequency module 122a and the second radio frequency module 122b are separately connected to the satellite communication chip 11, so that the first antenna 12a and the second antenna 12b work together for implementing a satellite communication function of the mobile terminal. At least a part of the first radiator 121a and at least a part of the second radiator 121b are located on different sides of the mobile terminal, so that a beam direction of the first radiator 121a is different from a beam direction of the second radiator 121b, thereby expanding coverage of the entire satellite antenna system of the mobile terminal.

FIG. 4 shows a downlink directivity pattern of the satellite antenna system of the mobile terminal in the embodiment shown in FIG. 3. A solid line represents a directivity pattern of receiving the radio frequency signal of the communication satellite through the first antenna 12a, and a dotted line represents a directivity pattern of receiving the radio frequency signal of the communication satellite through the second antenna 12b. As shown in FIG. 4, the first antenna 12a and the second antenna 12b are both configured to receive the radio frequency signal of the communication satellite. An area of weak angle-dependent receiving sensitivity, or effective isotropic sensitivity (EIS), of the first antenna 12a at least partially overlaps an area of strong angle-dependent receiving sensitivity of the second antenna 12b. It may be understood that there is a complementary relationship between the directivity pattern of the first antenna 12a and the directivity pattern of the second antenna 12b. Therefore, a total area covered by an area of strong angle-dependent receiving sensitivity of the first antenna 12a and the area of strong angle-dependent receiving sensitivity of the second antenna 12b is relatively large, so that the satellite antenna system of the mobile terminal covers a relatively wide area. In this way, difficulty in satellite alignment during use is reduced, and the mobile terminal can receive the radio frequency signal of the communication satellite in a relatively large quantity of poses. This helps improve a downlink communication effect of communication satellite-based communication on the mobile terminal, so that the mobile terminal can have a function of receiving a call through communication satellite-based communication.

In an embodiment, each of the at least two antennas 12 of the mobile terminal includes a corresponding radiator 121 and a corresponding radio frequency module 122, the radiator 121 of each antenna 12 is connected to the corresponding radio frequency module 122, and the corresponding radio frequency module 122 is connected to the satellite communication chip 11. Each antenna 12 is configured to receive a signal radiated by the communication satellite. An area of strong angle-dependent receiving sensitivity of the satellite antenna system covers at least 80% of a full sphere, so that the satellite antenna system may be considered as an omnidirectional antenna system. In an embodiment, that the area of strong angle-dependent receiving sensitivity of the satellite antenna system covers at least 80% of the full sphere means discrete value coverage during detection of an angle-dependent receiving sensitivity of the satellite antenna system, a discrete value is detected. The omnidirectional antenna system means that the area of strong EIS of the mobile terminal in free space covers at least 80% of the full sphere. The full sphere refers to a range of elevation angles from 0° to 180° and a range of azimuth angles from 0° to 360° in spherical coordinates. The area of strong EIS refers to an area in which the communication satellite can be received through the antenna.

The area of strong angle-dependent receiving sensitivity of the satellite antenna system may be continuous or discontinuous, provided that the total area of strong angle-dependent receiving sensitivity covers at least 80% of the full sphere.

In this embodiment, the satellite antenna system of the mobile terminal is the omnidirectional antenna system. The satellite antenna system has a strength within an omnidirectional range of the spherical coordinates. In this case, the mobile terminal can communicate with the communication satellite without remaining in a pose. The mobile terminal can receive the radio frequency signal of the communication satellite in a normal state, so that the mobile terminal remains in a called state. The normal state means that the mobile terminal does not perform an additional satellite alignment operation, and may be located at any position in free space, or may be located at any position such as a bag or a pocket. This solution can enrich satellite communication scenarios of the mobile terminal.

In an embodiment, a quantity of antennas 12 included in the satellite antenna system is not limited. Two, three, or more antennas 12 may be included. An area of weak angle-dependent receiving sensitivity of an antenna 12 in the satellite antenna system at least partially overlaps an area of strong angle-dependent receiving sensitivity of another antenna 12 in the satellite antenna system. In this embodiment, at least a part of an area of weak angle-dependent receiving sensitivity of an antenna 12 in the satellite antenna system is covered by an area of strong angle-dependent receiving sensitivity of another antenna 12, so that the satellite antenna system becomes the omnidirectional antenna system, or in other words, the satellite antenna system of the mobile terminal can omnidirectionally receive the radio frequency signal of the communication satellite.

The area of strong angle-dependent receiving sensitivity is an area in which an angle-dependent receiving sensitivity is less than or equal to a first threshold, and the area of weak angle-dependent receiving sensitivity is an area in which an angle-dependent receiving sensitivity is greater than the first threshold. When the angle-dependent receiving sensitivity of the satellite antenna system of the mobile terminal is less than or equal to the first threshold, the radio frequency signal of the communication satellite can be efficiently received, to implement communication of the mobile terminal. On the contrary, when the angle-dependent receiving sensitivity of the satellite antenna system of the mobile terminal is greater than the first threshold, it is difficult to receive the radio frequency signal of the communication satellite, or quality of the radio frequency signal received from the communication satellite is poor, resulting in difficulty in implementing communication of the mobile terminal.

In an embodiment, the first threshold is –121 dBm. In this case, the area of strong angle-dependent receiving sensitivity is an area in which an angle-dependent receiving sensitivity is less than or equal to –121 dBm. For example, the angle-dependent receiving sensitivity is –123 dBm, –125 dBm, –130 dBm, –145 dBm, or –150 dBm. The area of weak angle-dependent receiving sensitivity is an area in which an angle-dependent receiving sensitivity is greater than –121 dBm. For example, the angle-dependent receiving sensitivity is –120 dBm, –115 dBm, –110 dBm, –105 dBm, or –100 dBm. In an embodiment, when the communication satellite is a Tiantong communication satellite or a SatNet communication satellite, the first threshold is –121 dBm; or when the communication satellite is a BeiDou communication satellite, the first threshold is –123.5 dBm.

In a further embodiment, the mobile terminal is further configured to transmit a signal to the communication satellite. At least one antenna 12 in the satellite antenna system is further configured to transmit a signal to the communication satellite. In other words, in the satellite antenna system, only one antenna 12 may be configured to transmit a signal to the communication satellite, or two or more antennas 12 may be configured to transmit a signal to the communication satellite. Alternatively, in the satellite antenna system, each antenna 12 may be configured to transmit a signal to the communication satellite.

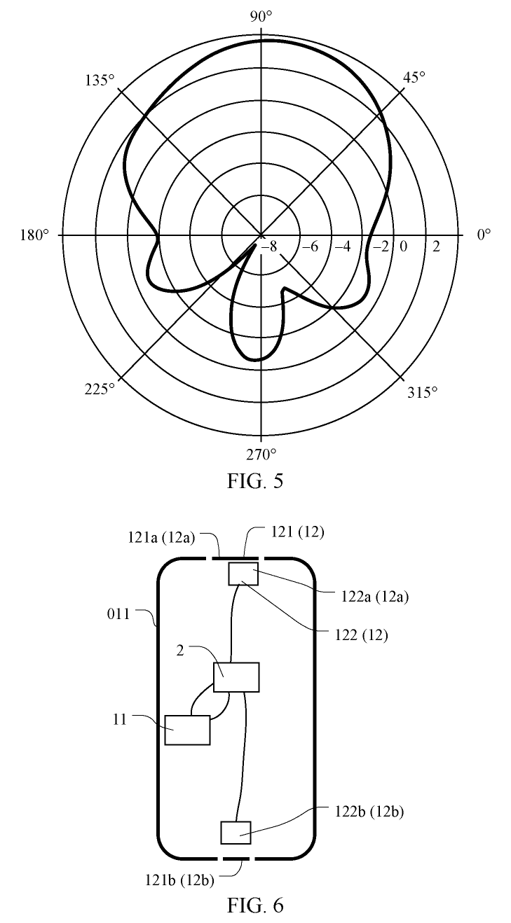

FIG. 5 shows an uplink directivity pattern of the satellite antenna system of the mobile terminal in the embodiment shown in FIG. 3. In an embodiment shown in FIG. 5, the first antenna 12a is configured to transmit a signal to the communication satellite. As shown in FIG. 5, an area of strong angle-dependent transmitting sensitivity, or effective isotropic radiated power (EIRP) of the satellite antenna system covers at least 80% of an upper hemisphere of the mobile terminal in use. The upper hemisphere refers to a range of elevation angles from 0° to 90° and a range of azimuth angles from 0° to 360° in spherical coordinates. The upper hemisphere is an upper hemisphere of the mobile terminal in a an example pose. For example, when the mobile terminal is in a pose of being held in a hand (for example, in a scenario in which the mobile terminal is held in the hand to make a call), the upper hemisphere of the mobile terminal is a hemisphere in which a top part of the mobile terminal is located. When the mobile terminal is in a free pose (for example, in a scenario in which a Bluetooth headset is used to make a call and the mobile terminal is located in a pocket, on a table, or inside a bag), the upper hemisphere of the mobile terminal is a hemisphere in which an upper part of the mobile terminal is located, which may be a hemisphere in which a side, a display side, or the like of the mobile terminal is located.

In the at least two antennas of the satellite antenna system of the mobile terminal provided in this disclosure, a quantity of antennas configured to transmit a signal to the communication satellite is not limited.

In an embodiment, one of the antennas 12 in the satellite antenna system is configured to transmit a signal to the communication satellite, and the antenna 12 is a wide-beam antenna, so that the area of strong angle-dependent transmitting sensitivity can cover at least 80% of the upper hemisphere of the mobile terminal.

In an embodiment, the at least two antennas 12 in the satellite antenna system are further configured to transmit a signal to the communication satellite. In the antennas 12 configured to transmit a signal to the communication satellite, an area of weak angle-dependent transmitting sensitivity of an antenna 12 at least partially overlaps an area of strong angle-dependent transmitting sensitivity of another antenna 12. In this embodiment, in the antennas 12 that are in the satellite antenna system and that are configured to transmit a signal to the communication satellite, an area of weak angle-dependent transmitting sensitivity of an antenna 12 is at least partially covered by an area of strong angle-dependent transmitting sensitivity of another antenna 12, so that coverage of the area of strong angle-dependent transmitting sensitivity of the satellite antenna system of the mobile terminal is expanded, and call quality of the mobile terminal is improved.

The area of strong angle-dependent transmitting sensitivity is an area in which an angle-dependent transmitting sensitivity is greater than or equal to a second threshold, and the area of weak angle-dependent transmitting sensitivity is an area in which an angle-dependent transmitting sensitivity is less than the second threshold. When an angle-dependent transmitting sensitivity of the satellite antenna system of the mobile terminal is greater than or equal to the second threshold, a signal can be efficiently transmitted to the communication satellite, to implement communication of the mobile terminal. On the contrary, when the angle-dependent transmitting sensitivity of the satellite antenna system of the mobile terminal is less than the second threshold, it is difficult to transmit a signal to the communication satellite, resulting in difficulty in implementing communication of the mobile terminal.

In an embodiment, the second threshold is 25.5 dBm. In this case, the area of strong angle-dependent transmitting sensitivity is an area in which an angle-dependent transmitting sensitivity is greater than or equal to 25.5 dBm, and the area of weak angle-dependent transmitting sensitivity is an area in which an angle-dependent transmitting sensitivity is less than 25.5 dBm. In an embodiment, when the communication satellite is a Tiantong communication satellite, the second threshold is 27 dBm; when the communication satellite is a SatNet communication satellite, the second threshold is 26 dBm; or when the communication satellite is a BeiDou communication satellite, the second threshold is 25.5 dBm.

The radio frequency module 122 of the antenna 12 that is in the satellite antenna system and that is configured to transmit the signal to the communication satellite includes a power amplifier (PA), and the power amplifier is configured to process the signal transmitted to the communication satellite. In an embodiment, the radio frequency module 122 of each antenna 12 in the satellite antenna system includes a power amplifier, and the power amplifier is connected to the satellite communication chip 11, so that each antenna 12 in the satellite antenna system can transmit a signal to the communication satellite, to improve call quality of the mobile terminal.

In an embodiment, the first antenna 12a and the second antenna 12b are both configured to transmit a signal to the communication satellite. The first radio frequency module 122a of the first antenna 12a includes a first power amplifier, the second radio frequency module 122b of the second antenna 12b includes a second power amplifier, and the first power amplifier and the second power amplifier are separately connected to the satellite communication chip 11. A distance between the first radiator 121a and the first power amplifier is less than a distance between the second radiator 121b and the first power amplifier. In an embodiment, a distance between the second radiator 121b and the second power amplifier is less than a distance between the first radiator 121a and the second power amplifier. A distance between a power amplifier and a connected radiator 121 is less than a distance between the power amplifier and another radiator 121. If the distance between the power amplifier and the connected radiator 121 is relatively short, a line connecting the power amplifier and the radiator 121 is relatively short, thereby reducing a plate-level transmission loss, reducing a link loss, and improving signal transmission efficiency.

In an embodiment, the power amplifier is a distributed radio frequency terminal. In an embodiment, the distance between the power amplifier of the mobile terminal and the connected radiator 121 is less than a distance between the power amplifier and the satellite communication chip 11. A power amplifier of an antenna 12 is disposed closer to a connected radiator 121, thereby helping reduce the link loss.

In an embodiment, a distance between the power amplifier of the antenna 12 and the connected radiator 121 is less than or equal to 20 mm. In this case, a line distance between the power amplifier of the antenna 12 and the radiator 121 is also relatively short.

FIG. 6 is a diagram of a structure of a mobile terminal according to an embodiment of this disclosure. As shown in FIG. 6, the mobile terminal further includes a control switch 2, where the control switch 2 is connected to the satellite communication chip 11, and the control switch 2 is connected to the radio frequency modules 122 of all the antennas 12. It may be understood that the control switch 2 is connected between the radio frequency module 122 of the antenna 12 and the satellite communication chip 11, and is configured to control a connection relationship between the antenna 12 and the satellite communication chip 11, to select the antenna 12 used for communication. The control switch 2 is configured to connect one or more antennas 12 to the satellite communication chip 11 based on a pose of the mobile terminal and/or a position of an area of strong angle-dependent transmitting sensitivity of the antenna 12. It may be understood that the one or more antennas 12 connected to the satellite communication chip 11 are in a working state for signal transmission.

In an embodiment, the control switch 2 may select a working antenna 12 based on the pose of the mobile terminal. For example, in a state in which the mobile terminal is held in the hand to make a call, the mobile terminal is approximately in a vertical state. In this case, the control switch 2 connects a radio frequency module 122 of an antenna 12 whose radiator 121 is located at the top part of the mobile terminal to the satellite communication chip 11, and a beam of the radiator 121 located at the top part of the mobile terminal faces upward, so that a signal transmission effect of the communication satellite is relatively good. In addition, a user may further make a call by using Bluetooth or a speaker. In this scenario, there may be a plurality of choices for the pose of the mobile terminal. In this case, the control switch 2 may connect one or more antennas 12 facing upward in a pose of the mobile terminal to be in a working state, to improve a communication effect of the mobile terminal.

In an embodiment, the mobile terminal includes an accelerometer (G-sensor), and the pose of the mobile terminal may be monitored through the accelerometer-sensor.

In an embodiment, the control switch 2 may connect one or more antennas 12 to be in a working state based on a position of an area of strong angle-dependent transmitting sensitivity of the antenna 12. The control switch 2 may choose to connect the one or more antennas 12 to be in the working state based on a relationship between a position of the communication satellite and the position of the area of strong angle-dependent transmitting sensitivity of the antenna 12. An antenna 12 whose area of strong angle-dependent transmitting sensitivity faces the communication satellite is enabled to be in a working state.

In an embodiment, the control switch 2 may further select, by comparing transmit signal strengths of different antennas 12, one or more antennas 12 with a higher transmit signal strength to be in a working state.

In addition to selecting the antennas 12 for uplink communication, the control switch 2 may be further configured to select an antenna 12 for downlink communication. In an embodiment, the control switch 2 of the mobile terminal selects, by comparing received signal strengths of different antennas 12, one or more antennas 12 with a higher received signal strength to be in a working state.

In an embodiment, the antennas 12 for downlink communication may work simultaneously, to improve a signal receiving capability of the mobile terminal.

In this embodiment of this disclosure, a side frame of the mobile terminal is a metal side frame. For example, the metal side frame may be a middle frame of the mobile terminal. A partial structure of the metal side frame forms the radiator 121 of the antenna 12. In this embodiment, the radiator 121 of the antenna 12 may be reused with the middle frame of the mobile terminal, to reduce space occupied by the radiator 121 of the antenna 12 and improve integration of the mobile terminal. In addition, the radiator 121 of the antenna 12 is less blocked, which helps improve a communication effect of the antenna 12.

In this embodiment of this disclosure, a quantity of antennas 12 included in the satellite antenna system of the mobile terminal is not limited. The following lists several embodiments.

As shown in FIG. 3 and FIG. 6, in an embodiment, the satellite antenna system includes two antennas 12, where the two antennas 12 are respectively the first antenna 12a and the second antenna 12b. The first radiator 121a and the second radiator 121b of the satellite antenna system are respectively disposed on two sides of the mobile terminal that are away from each other. The first antenna 12a and the second antenna 12b are both configured to receive the radio frequency signal of the communication satellite, and at least one of the first antenna 12a and the second antenna 12b is configured to transmit a signal to the communication satellite.

In an embodiment, as shown in FIG. 6, the first antenna 12a and the second antenna 12b are both configured to receive the radio frequency signal of the communication satellite, and the first antenna 12a and the second antenna 12b are both configured to transmit the signal to the communication satellite. To implement the foregoing functions, the first radio frequency module 122a of the first antenna 12a includes a power amplifier and a low-noise amplifier (LNA), and the second radio frequency module 122b of the second antenna 12b also includes a power amplifier and a low noise amplifier.

In the embodiments shown in FIG. 3 and FIG. 6, the first radiator 121a of the first antenna 12a is disposed on a side of the top part of the mobile terminal, and the second radiator 121b of the second antenna 12b is disposed on a side of a bottom part of the mobile terminal.

For a downlink directivity pattern of the satellite antenna system that is of the mobile terminal and that includes two antennas 12, refer to FIG. 4. There is a complementary relationship between the directivity pattern of the first antenna 12a and the directivity pattern of the second antenna 12b. Therefore, the total area covered by the area of strong angle-dependent receiving sensitivity of the first antenna 12a and the area of strong angle-dependent receiving sensitivity of the second antenna 12b is relatively large, so that the satellite antenna system of the mobile terminal covers a relatively wide area, and the satellite antenna system is the omnidirectional antenna system. In this way, difficulty in satellite alignment during use is reduced, and the mobile terminal can receive the radio frequency signal of the communication satellite in a relatively large quantity of poses. This helps improve the downlink communication effect of communication satellite-based communication on the mobile terminal, so that the mobile terminal can have the function of receiving a call through communication satellite-based communication.

In an embodiment, the area of strong EIS of the first antenna 12a covers at least elevation angles from 0° to 90° and azimuth angles from 0° to 360° in spherical coordinates; and the area of strong EIS of the second antenna 12b covers at least 90° to 180° and azimuth angles from 0° to 360° in spherical coordinates. In an embodiment, the area of strong EIS of the first antenna 12a covers at least elevation angles from 0° to 80° and azimuth angles from 0° to 360° in spherical coordinates; and the area of strong EIS of the second antenna 12b covers at least elevation angles from 100° to 180° and azimuth angles from 0° to 360° in spherical coordinates.

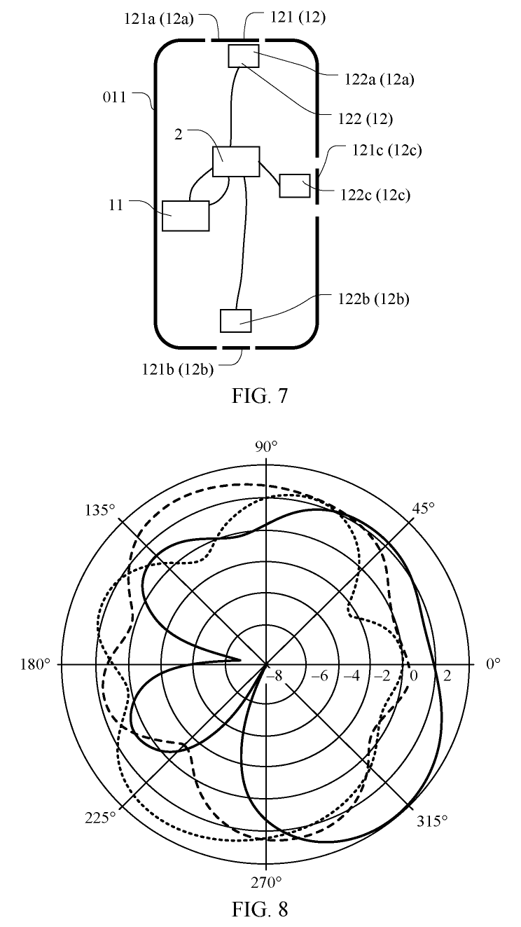

FIG. 7 is a diagram of a structure of a mobile terminal according to an embodiment of this disclosure. As shown in FIG. 7, in an embodiment, the satellite antenna system of the mobile terminal in this disclosure includes three antennas 12. The satellite antenna system includes the first antenna 12a, the second antenna 12b, and a third antenna 12c. The third antenna 12c includes a third radiator 121c and a third radio frequency module 122c that are connected to each other, the third radio frequency module 122c is connected to the satellite communication chip 11, and the first radiator 121a, the second radiator 121b, and the third radiator 121c are respectively disposed on three different sides of the mobile terminal. In this way, downlink directivity patterns of the three antennas are complementary to each other, enabling a communication capability across a wider area.

In an embodiment, the first antenna 12a, the second antenna 12b, and the third antenna 12c are all configured to receive a radio frequency signal of the communication satellite. FIG. 8 shows a downlink directivity pattern of the satellite antenna system of the mobile terminal in the embodiment shown in FIG. 7. A solid line represents a directivity pattern of receiving the radio frequency signal of the communication satellite through the first antenna 12a, a dotted line represents a directivity pattern of receiving the radio frequency signal of the communication satellite through the second antenna 12b, and a dashed line represents a directivity pattern of receiving the radio frequency signal of the communication satellite through the third antenna 12c. As shown in FIG. 8, there is a complementary relationship between the directivity pattern of the first antenna 12a, the directivity pattern of the second antenna 12b, and the directivity pattern of the third antenna 12c. Therefore, a total area covered by the area of strong angle-dependent receiving sensitivity of the first antenna 12a, the area of strong angle-dependent receiving sensitivity of the second antenna 12b, and an area of strong angle-dependent receiving sensitivity of the third antenna 12c is relatively large, so that the satellite antenna system of the mobile terminal covers a relatively wide area, and the satellite antenna system is the omnidirectional antenna system. In this way, difficulty in satellite alignment during use is reduced, and the mobile terminal can receive the radio frequency signal of the communication satellite in a relatively large quantity of poses. This helps improve the downlink communication effect of communication satellite-based communication on the mobile terminal, so that the mobile terminal can have the function of receiving a call through communication satellite-based communication.

In an embodiment, the area of strong EIS of the first antenna 12a covers at least elevation angles from 0° to 60° and azimuth angles from 0° to 360° in spherical coordinates; the area of strong EIS of the second antenna 12b covers at least elevation angles from 60° to 180° and azimuth angles from 180° to 360° in spherical coordinates; and an area of strong EIS of the third antenna 12c covers at least elevation angles from 60° to 180° and azimuth angles from 0° to 180° in spherical coordinates.

In an embodiment, the first antenna 12a, the second antenna 12b, and the third antenna 12c are further configured to transmit a signal to the communication satellite. The first radio frequency module 122a of the first antenna 12a includes a power amplifier and a low noise amplifier, the second radio frequency module 122b of the second antenna 12b also includes a power amplifier and a low noise amplifier, and the third radio frequency module 122c of the third antenna 12c also includes a power amplifier and a low noise amplifier.

As shown in FIG. 7, in an embodiment, the first radiator 121a of the first antenna 12a is disposed on a side of the top part of the mobile terminal, the second radiator 121b of the second antenna 12b is disposed on a side of a bottom part of the mobile terminal, and the third radiator 121c of the third antenna 12c is disposed on a side of a side part of the mobile terminal.

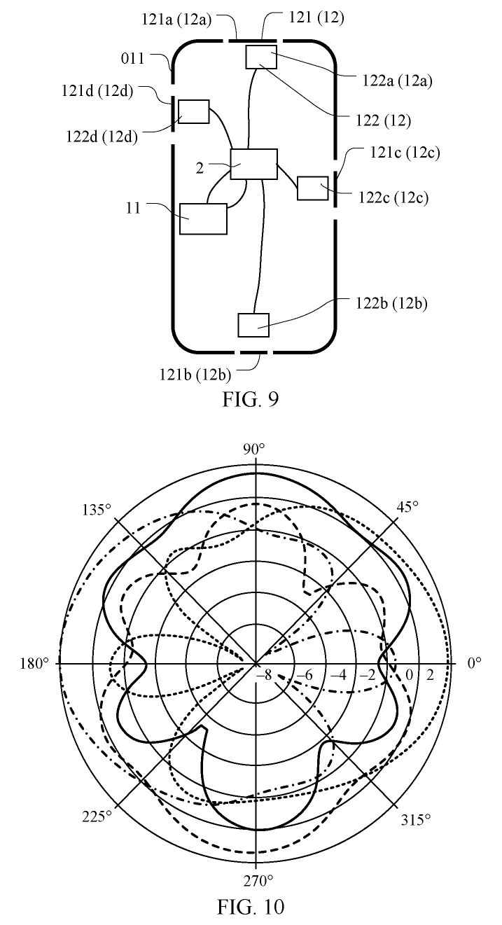

FIG. 9 is a diagram of another structure of a mobile terminal according to an embodiment of this disclosure. As shown in FIG. 9, in an embodiment, the satellite antenna system of the mobile terminal in this disclosure includes four antennas 12. The satellite antenna system includes the first antenna 12a, the second antenna 12b, a third antenna 12c, and a fourth antenna 12d. The fourth antenna 12d includes a fourth radiator 121d and a fourth radio frequency module 122d that are connected to each other, the fourth radio frequency module 122d is connected to the satellite communication chip 11, and the first radiator 121a, the second radiator 121b, the third radiator 121c, and the fourth radiator 121d are respectively disposed on four different sides of the mobile terminal.

In an embodiment, the first antenna 12a, the second antenna 12b, the third antenna 12c, and the fourth antenna 12d are all configured to receive a radio frequency signal of the communication satellite. FIG. 10 shows a downlink directivity pattern of the satellite antenna system of the mobile terminal in the embodiment shown in FIG. 9. A solid line represents a directivity pattern of receiving the radio frequency signal of the communication satellite through the first antenna 12a, a dotted line represents a directivity pattern of receiving the radio frequency signal of the communication satellite through the second antenna 12b, a dashed line represents a directivity pattern of receiving the radio frequency signal of the communication satellite through the third antenna 12c, and a dash-dotted line represents a directivity pattern of receiving the radio frequency signal of the communication satellite through the fourth antenna 12d. As shown in FIG. 10, there is a complementary relationship between the directivity pattern of the first antenna 12a, the directivity pattern of the second antenna 12b, the directivity pattern of the third antenna 12c, and the directivity pattern of the fourth antenna 12d. Therefore, a total area covered by the area of strong angle-dependent receiving sensitivity of the first antenna 12a, the area of strong angle-dependent receiving sensitivity of the second antenna 12b, an area of strong angle-dependent receiving sensitivity of the third antenna 12c, and an area of strong angle-dependent receiving sensitivity of the fourth antenna 12d is relatively large, so that the satellite antenna system of the mobile terminal covers a relatively wide area, and the satellite antenna system is the omnidirectional antenna system. In this way, difficulty in satellite alignment during use is reduced, and the mobile terminal can receive the radio frequency signal of the communication satellite in a relatively large quantity of poses. This helps improve the downlink communication effect of communication satellite-based communication on the mobile terminal, so that the mobile terminal can have the function of receiving a call through communication satellite-based communication.

In an embodiment, the area of strong EIS of the first antenna 12a covers at least elevation angles from 0° to 45° and azimuth angles from 0° to 360° in spherical coordinates; the area of strong EIS of the second antenna 12b covers at least elevation angles from 135° to 180° and azimuth angles from 0° to 360° in spherical coordinates; an area of strong EIS of the third antenna 12c covers at least elevation angles from 45° to 135° and azimuth angles from 0° to 180° in spherical coordinates; and an area of strong EIS of the fourth antenna 12d covers at least elevation angles from 45° to 135° and azimuth angles from 180° to 360° in spherical coordinates.

The first antenna 12a, the second antenna 12b, the third antenna 12c, and the fourth antenna 12d are further configured to transmit a signal to the communication satellite. The first radio frequency module 122a of the first antenna 12a includes a power amplifier and a low noise amplifier, the second radio frequency module 122b of the second antenna 12b also includes a power amplifier and a low noise amplifier, the third radio frequency module 122c of the third antenna 12c also includes a power amplifier and a low noise amplifier, and the fourth radio frequency module 122d of the fourth antenna 12d also includes a power amplifier and a low noise amplifier.

The foregoing descriptions are merely implementations of this disclosure, but are not intended to limit the protection scope of this disclosure. Any variation or replacement readily figured out by a person skilled in the art within the technical scope disclosed in this disclosure shall fall within the protection scope of this disclosure. Therefore, the protection scope of this disclosure shall be subject to the protection scope of the claims.

What is claimed is:

1. A mobile terminal, comprising: a first side; a second side; and a satellite antenna system comprising: a satellite communication chip configured to implement at least one of satellite messaging, satellite calling, or satellite internet access; a first antenna coupled to the satellite communication chip, configured to receive a radio frequency signal of a communication satellite, and comprising: a first area of weak angle-dependent receiving sensitivity; a first radiator at least partially located on the first side; and a first radio frequency system coupled between the first radiator and the satellite communication chip; and a second antenna coupled to the satellite communication chip, configured to receive the radio frequency signal, and comprising: a second area of strong angle-dependent receiving sensitivity overlapping the first area; a second radiator at least partially located on the second side; and a second radio frequency system coupled between the second radiator and the satellite communication chip.

2. The mobile terminal of claim 1, wherein the satellite antenna system is an omnidirectional antenna system, and wherein the satellite antenna system comprises a third area of strong angle-dependent receiving sensitivity covering at least 80% of a full sphere.

3. The mobile terminal of claim 1, wherein the second area has a first angle-dependent receiving sensitivity less than or equal to a first threshold, and wherein the first area has a second angle-dependent receiving sensitivity greater than the first threshold.

4. The mobile terminal of claim 3, wherein the first threshold is -121 decibel-milliwatts (dBm).

5. The mobile terminal of claim 1, wherein at least one of the first antenna or the second antenna is further configured to transmit a signal to the communication satellite, and wherein the satellite antenna system comprises a third area of strong angle-dependent transmitting sensitivity covering at least 80% of an upper hemisphere of the mobile terminal during use.

6. The mobile terminal of claim 1, wherein the first antenna is configured to transmit a first signal to the communication satellite, wherein the second antenna is configured to transmit a second signal to the communication satellite, wherein the second antenna further comprises a fourth area of strong angle-dependent transmitting sensitivity, and wherein the first antenna further comprises a third area of weak angle-dependent transmitting sensitivity overlapping the fourth area.

7. The mobile terminal of claim 6, wherein the fourth area has a first angle-dependent transmitting sensitivity greater than or equal to a second threshold, and wherein the third area has a second angle-dependent transmitting sensitivity less than the second threshold.

8. The mobile terminal of claim 7, wherein the second threshold is 25.5 decibel-milliwatts (dBm).

9. The mobile terminal of claim 1, wherein the first radio frequency system comprises a first power amplifier, wherein the second radio frequency system comprises a second power amplifier, wherein the first antenna is further configured to transmit a first signal to the communication satellite, and wherein the second antenna is further configured to transmit a second signal to the communication satellite.

10. The mobile terminal of claim 5, further comprising a control switch connected to the satellite communication chip, the first radio frequency system, and the second radio frequency system, wherein the control switch is configured to connect one or more of the first antenna or the second antenna to the satellite communication chip based on a pose of the mobile terminal, a first transmit signal strength of the first antenna, a second transmit signal strength of the second antenna, a first position of a fourth area of strong angle-dependent transmitting sensitivity of the first antenna, or a second position of a fifth area of strong angle-dependent transmitting sensitivity of the second antenna.

11. The mobile terminal of claim 1, further comprising a metal side frame, wherein the metal side frame comprises:
a first part forming the first radiator; and
a second part forming the second radiator.

12. The mobile terminal of claim 1, wherein the first side is spaced away from the second side.

13. The mobile terminal of claim 1, further comprising a third side, wherein the satellite antenna system further comprises a third antenna, and wherein the third antenna comprises: a third radiator located on the third side; and a third radio frequency system connected to the third radiator and the satellite communication chip.

14. The mobile terminal of claim 1, further comprising a third side and a fourth side, wherein the satellite antenna system further comprises: a third antenna comprising: a third radiator located on the third side; and a third radio frequency system connected to the third radiator and the satellite communication chip; and a fourth antenna comprising: a fourth radiator located on the fourth side; and a fourth radio frequency system connected to the fourth radiator and the satellite communication chip.

15. A mobile terminal, comprising: a satellite antenna system comprising: a satellite communication chip configured to implement at least one of satellite messaging, satellite calling, or satellite internet access; a first antenna configured to transmit a first signal to a communication satellite and comprising a second area of weak angle-dependent transmitting sensitivity; and a second antenna configured to transmit a second signal to the communication satellite and comprising a third area of strong angle-dependent transmitting sensitivity overlapping the second area, wherein the satellite antenna system is configured to have a first area of strong angle-dependent transmitting sensitivity covering at least 80% of an upper hemisphere of the mobile terminal during use.

16. The mobile terminal of claim 15, wherein the third area has a first angle-dependent transmitting sensitivity greater than or equal to a second threshold, and wherein the second area has a second angle-dependent transmitting sensitivity less than the second threshold.

17. The mobile terminal of claim 16, wherein the second threshold is 25.5 decibel-milliwatts (dBm).

18. The mobile terminal of claim 15, wherein the first antenna comprises a first power amplifier, and wherein the second antenna comprises a second power amplifier.

19. The mobile terminal of claim 15, further comprising a control switch connected to the satellite communication chip, the first antenna, and the second antenna, wherein the control switch is configured to connect one or more of the first antenna or the second antenna to the satellite communication chip based on a pose of the mobile terminal, a first transmit signal strength of the first antenna, a second transmit signal strength of the second antenna, a first position of the third area, or a second position of a fourth area of strong angle-dependent transmitting sensitivity of the first antenna.

20. An antenna system comprising: a first antenna configured to receive a radio frequency signal of a communication satellite and comprising: a first area of weak angle-dependent receiving sensitivity; a first radiator at least partially located on a first side of an electronic device; and a first radio frequency system coupled to the first radiator; and a second antenna configured to receive the radio frequency signal and comprising: a second area of strong angle-dependent receiving sensitivity overlapping the first area; a second radiator at least partially located on a second side of the electronic device; anda second radio frequency system coupled to the second radiator.
